(19) United States
(12) Patent Application Publication
(10) Pub. No.: US 2019/0051024 A1
(43) Pub. Date: Feb. 14, 2019

(54) Method of Processing Image Data and Related Device

(71) Applicant: ACER INCORPORATED, New Taipei City (TW)

(72) Inventors: Andy Ho, New Taipei City (TW); Tsung-Han Yang, New Taipei City (TW); Szu-Chieh Wang, New Taipei City (TW); Jian-Chi Lin, New Taipei City (TW); JASON HSIAO, New Taipei City (TW)

(21) Appl. No.: 15/986,823

(22) Filed: May 23, 2018

(30) Foreign Application Priority Data
Aug. 9, 2017 (TW) 106126862

(51) Int. Cl. G06T 11/20

(52) U.S. Cl. CPC G06T 11/206

(57) ABSTRACT

A method of processing image data for a low processing device comprises collecting data, performing a statistical operation on the collected data with the first data collection section as a first processing unit, to obtain a plurality of first statistical data for the first data collection section, and performing the statistical operation on at least two of the plurality of first statistical data with a second data collection section as a second processing unit, to obtain at least a second statistical data for the second data collection section, wherein the second data collection section is the accumulation of at least two first data collection sections.

### BACKGROUND OF THE INVENTION

### 1. Field of the Invention

The present disclosure relates to a method of processing image data, and more particularly, to a method of processing image data with different processing units.

### 2. Description of the Prior Art

In order to compute a customer number heat map and quickly display statistical graphs on a digital signage, the processor of the digital signage performs statistical operation on the data of each section in a database with the smallest processing unit. As a result, the processor of the digital signage may perform a large amount of calculation and consumes a lot of time.

For example, the store owner wants to know the total number of customers today and display the result in every hour with the heat map. If the processing unit for statistics is “minute”, which means the raw data is calculated once for each minute, to obtain “hour” result, 60 minutes of the raw data has to be added for statistical operation. Similarly, to obtain 12 hour result, 12*60 minutes of the raw data are added for statistical operation. In other words, the smaller (namely the more precise statistic) the processing unit is, the longer the time to display the heat map or the larger the amount of data calculation is. For example, to watch a heat map computed by a HD resolution monitor per minute, it is required to calculate the pixel value per minute, and thus the data calculation amount will be enlarged to 1920*768*12*60 times. In addition, if the store owner wants to watch the heat map in a form of monthly result, the data calculation amount will be enlarged by a factor of 30, not to mention the application of multiple monitors.

However, for low computing products such as the digital signage, long-term data calculation from the smallest processing unit is a heavy burden. If the digital signage can connect to a network to send the data back to a high-performance processor for calculation, there is no abovementioned problem, but networks in some countries may not be well developed. As a result, the digital signage with independently computing operations has greater benefits for productization.

### SUMMARY OF THE INVENTION

It is therefore an objective to provide a method of processing image data, to solve the above problems.

The present disclosure provides a method of processing image data for a low processing device. The method comprises collecting data, performing a statistical operation on the collected data with the first data collection section as a first processing unit, to obtain a plurality of first statistical data for the first data collection section, and performing the statistical operation on at least two of the plurality of first statistical data with a second data collection section as a second processing unit, to obtain at least a second statistical data for the second data collection section, wherein the second data collection section is the accumulation of at least two first data collection sections.

The present disclosure provides an image data processing device. The image data processing device comprises a detecting unit, for collecting data, a processing unit, for performing a statistical operation on the collected data with the first data collection section as a first processing unit, to obtain a plurality of first statistical data for the first data collection section, and performing the statistical operation on at least two of the plurality of first statistical data with a second data collection section as a second processing unit, to obtain at least a second statistical data for the second data collection section, wherein the second data collection section is the accumulation of at least two first data collection sections, and a storage unit, coupled to the processing unit, for storing the plurality of first statistical data and the at least a second statistical data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an image data processing device according to the present disclosure.

FIG. 2 is a flowchart of an exemplary process according to the present disclosure.

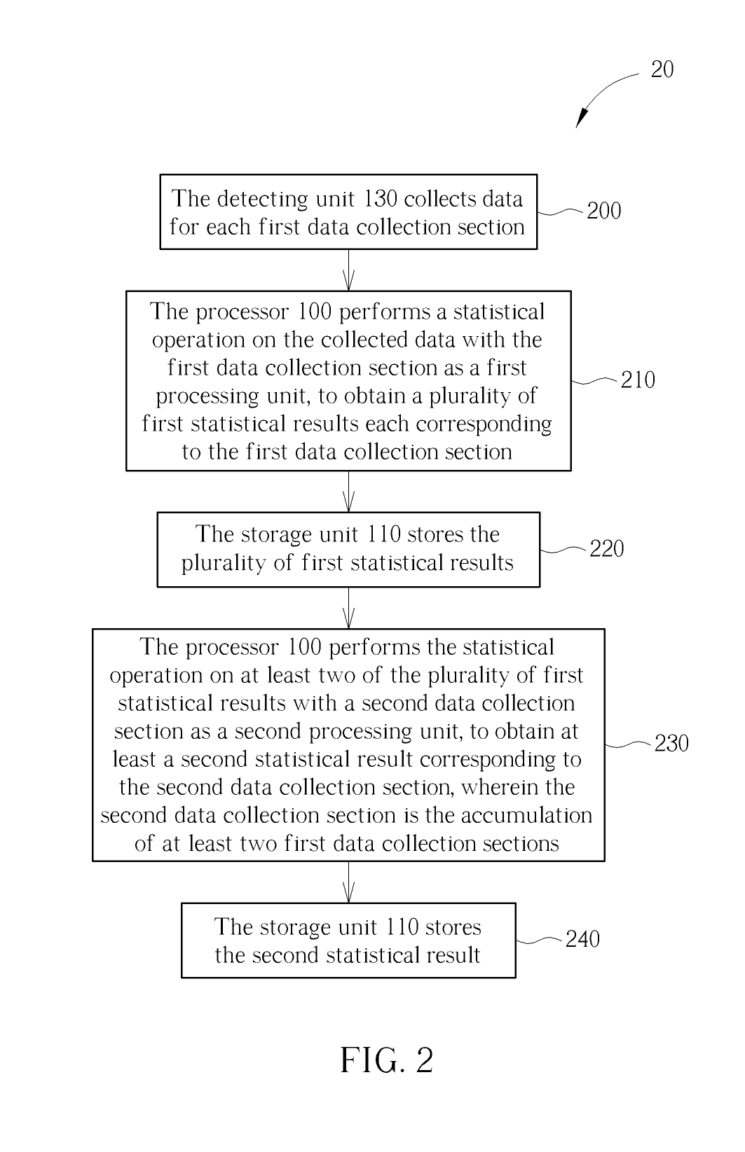

### DETAILED DESCRIPTION

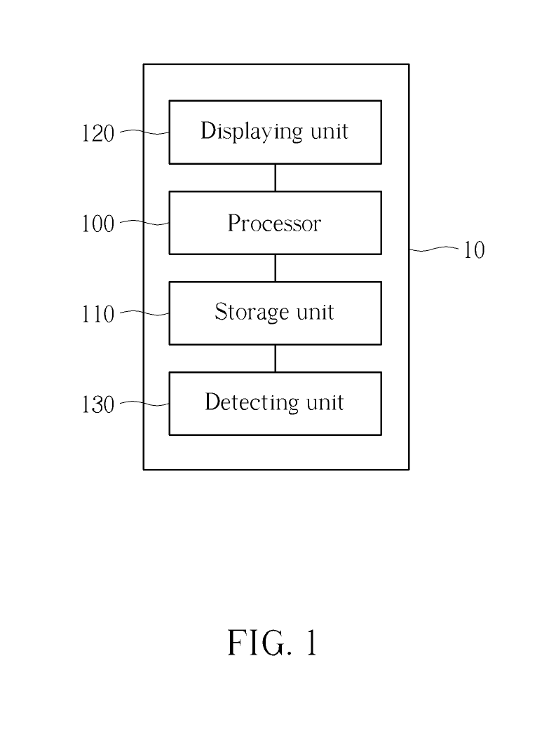

FIG. 1 is a schematic diagram of an image data processing device 10 according to the present disclosure. The image data processing device 10 could be a digital signage or a monitor, and includes a processor 100 such as Application Specific Integrated Circuit (ASIC), etc., a storage unit 110, a displaying unit 120 and a detecting unit 130. The storage unit 110 may be any data storage device that can store program code 114 corresponding to a process, for access by the processor 100. The processor 100 may be coupled to the storage unit 110, for processing the program code 114 to execute the process. Examples of the storage unit 110 include but are not limited to a read-only memory (ROM), flash memory, random-access memory (RAM), CD-ROMs, magnetic tape, hard disk, and optical data storage device. The displaying unit 120 is used for displaying processing results of the processor 100 with graphic manner (i.e. a heat map and any statistical graphs). The detecting unit 130 is used for collecting data and storing the collected data in the storage unit 110, wherein the data could be a real-time image or an image frame, which is not limited herein.

In addition, an operation of the image data processing device 10 is summarized into an image data process 20. Please refer to FIG. 4, which is a flowchart of the image data process 20 according to an example of the present disclosure. The image data process 20 may include the following steps:

Step 200: The detecting unit 130 collects data.

Step 210: The processor 100 performs a statistical operation on the collected data with the first data collection section as a first processing unit, to obtain a plurality of first statistical data for the first data collection section.

Step 220: The storage unit 110 stores the plurality of first statistical data.

Step 230: The processor 100 performs the statistical operation on at least two of the plurality of first statistical data with a second data collection section as a second processing unit, to obtain at least a second statistical data for the second data collection section, wherein the second data collection section is the accumulation of at least two first data collection sections.

Step 240: The storage unit 110 stores the second statistical data.

In a word, the image data processing device 10 first takes the data for the minimum data collection section (i.e. the first data collection section) into consideration, and therefore performs the statistical operation on the data (i.e. by performing a certain function on the data with the minimum data collection section) and stores the statistical data. Next, the image data processing device 10 processes the data with the second data collection section, wherein the second data collection section are composed of a plurality of minimum data collection sections, and consequentially performs the statistical operation on the stored statistical data corresponding to the multiple minimum data collection sections of the second data collection section with the same function, and stores the second statistical data. With such manner, statistical data for different data collection sections could be computed. Thus, the image data processing device 10 is able to decrease the calculation amount, and obtains the statistics in a short time.

In other words, for statistics in a large data collection section, the stored statistical data corresponding to a data collection section, which is one level smaller than the large data collection section, are used for statistical operation, so that the calculation amount will be less than that in the minimum data collection section. Therefore, the image data process 20 can effectively reduce the amount of data calculation and reaction time of the system (i.e. shortening the time for displaying the statistical result of the heat map).

In an embodiment, the store owner wants to know the total number of customers in a day and display the statistical result with the heat map. According to the image data process 20, the collected raw data is performed with the statistical operation in every minute (namely the processing unit is in “minute”), and then the statistical data of 60 minutes are added for further statistical operation, so as to obtain a statistical data of an hour. With such manner, the statistical data of 12 hours are consequently obtained. That is, when the store owner wants to display the heat map in a day, the processor 100 adds the statistical data of 12 hours for statistical operation, and then obtains the customer statistics in a day for heat map displaying. Moreover, if the store owner wants to display the customer statistics in a month, the processor 100 adds the statistical data of 30 days for statistical operation, and then obtains statistical data of a month. Similarly, to obtain statistical data of a year, the statistical data of 12 months are added for statistical operation, so that the customer statistics in a year is computed for displaying.

As abovementioned, collected data is calculated with data collection sections corresponding to different levels of processing unit such as “minute”, “hour”, “day”, “week”, “month” and “year” and then respectively stored. Thus, upon data displaying, the processor 100 calculates the stored data only in previous level of processing unit. For example, the store owner wants to watch the customer statistics in a year. The processor 100 calculates the stored data only in “month” (namely adding statistical data of 12 months for statistical operation), where the statistical data in “month” has been calculated and stored during an accumulation of the statistical operation (namely calculating from minute, hour, day, week to month). As a result, it does not have to calculate from the raw data to display the statistical result in “year”.

Furthermore, since the statistical data in different data collection sections has been calculated and stored, an user can select the statistical data to be watch (i.e. watching the “month” or “year” statistical data), and the selected statistical data can be quickly displayed. Besides, the statistical data calculated with different data collection sections is stored with index, so that the processor 100 can quickly find the statistical data in a data collection section, to increase the operation speed for each data collection section.

Note that, the present invention is not only applicable to time data, but also spatial data such as a map with various levels. The processor 100 performs statistical operation with different processing units according to the corresponding data collection sections. The processing unit includes time, space, volume, and area, but is not limited thereto. For example, the degree of urbanization (or population density) of an administrative region is calculated with an area as the processing unit, and levels of the processing unit may include a “building area” (e.g. 1000 square meters), “zone” of square kilometers (e.g. 10 square kilometers), and “county” (e.g. 100 square kilometers). First of all, the collected data is calculated with square meter as the minimum processing unit, to obtain the statistical data for the number of households in “building area”, and store the statistical data corresponding to the square meter. After that, the stored statistical data corresponding to the square meter is used for calculating the next level of the processing unit, to obtain the statistical data for the number of households in “zone”, and so on. With such manner, the average population density of the county and city can be obtained, so as to derive the degree of urbanization of the city. In this embodiment, the data collection section is associated to space, which can reduce the calculation and reaction time for statistics in a large area of the city.

The abovementioned steps of the processes/operations including suggested steps can be realized by means that could be a hardware, a software, or a firmware known as a combination of a hardware device and computer instructions and data that reside as read-only software on the hardware device or an electronic system. In an embodiment, the storage unit 110 of the image data processing device 10 stores storage data, which includes a program code compiled with the image data process 20, and executed by the processor 100 for realizing the steps of the image data process 20. In addition, examples of hardware can include analog, digital and mixed circuits known as microcircuit, microchip, or silicon chip. Examples of the electronic system can include a system on chip (SOC), system in package (SiP), a computer on module (COM) and the image data processing device 10.

In conclusion, the present invention provides the image data processing method for reducing the amount of calculation and reaction time to quickly display the heat map. The concept is addressed at usage of stored statistical data corresponding to a first data collection section, which is one level smaller than a second data collection section, for computing statistic in a large data collection section. Although it increases the amount of data storage, the currently inexpensive storage unit is more optimal than the network instability and the cost for high-performance computing.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of processing image data for a low processing device, the method comprising:
collecting data;
performing a statistical operation on the collected data with the first data collection section as a first processing unit, to obtain a plurality of first statistical data for the first data collection section; and
performing the statistical operation on at least two of the plurality of first statistical data with a second data collection section as a second processing unit, to obtain at least a second statistical data for the second data collection section, wherein the second data collection section is the accumulation of at least two first data collection sections.

2. The method of claim 1, further comprising:
storing the plurality of first statistical data and the at least a second statistical data with an index store manner.

3. The method of claim 1, wherein the second data collection section is an integer multiple of the data collection first section.

4. The method of claim 1, wherein the processing unit includes time, space, volume and area.

5. The method of claim 1, further comprising:
displaying the plurality of first statistical data and the at least a second statistical data with a heat map.

6. An image data processing device comprising:
a detecting unit, for collecting data;
a processing unit, for performing a statistical operation on the collected data with the first data collection section as a first processing unit, to obtain a plurality of first statistical data for the first data collection section, and performing the statistical operation on at least two of the plurality of first statistical data with a second data collection section as a second processing unit, to obtain at least a second statistical data for the second data collection section, wherein the second data collection section is the accumulation of at least two first data collection sections; and
a storage unit, coupled to the processing unit, for storing the plurality of first statistical data and the at least a second statistical data.

7. The image data processing device of claim 6, wherein the storage unit is used for storing the plurality of first statistical data and the at least a second statistical data with an index store manner.

8. The image data processing device of claim 6, wherein the second data collection section is an integer multiple of the data collection first section.

9. The image data processing device of claim 6, wherein the processing unit includes time, space, volume and area.

10. The image data processing device of claim 6, wherein the plurality of first statistical data and the at least a second statistical data is associated to information of a heat map.

11. The image data processing device of claim 10, further comprising:
a displaying unit, for displaying the heat map.

12. The image data processing device of claim 6, wherein the collected data includes a real-time image and an image frame.
